(19) United States
(12) Patent Application Publication
(10) Pub. No.: US 2020/0294041 A1
(43) Pub. Date: Sep. 17, 2020

(54) Real-Time Processing Of Transactions For Centralized Blockchains

(71) Applicant: SAP SE, Walldorf (DE)

(72) Inventors: Alexander Ocher, San Jose, CA (US); Viktor Lapitski, Mountain View, CA (US); Andrey Belyy, Sunnyvale, CA (US)

(21) Appl. No.: 16/352,570

(22) Filed: Mar. 13, 2019

(51) Int. Cl. G06Q 20/38; G06F 16/182; H04L 9/08; H04L 9/32

(52) U.S. Cl. CPC G06Q 20/3829; G06F 16/1824; H04L 2209/56; H04L 9/3247; H04L 2209/38; H04L 9/0838

(57) ABSTRACT

Some embodiments provide a non-transitory machine-readable medium that stores a program. The program receives a transaction from a transaction source. Based on a set of rules configured for processing transactions, the program further determines a blockchain from a plurality of blockchains stored in memory of the device. The program also records the transaction to the determined blockchain in the memory of the device.

### BACKGROUND

Lately, the use of blockchain technology has been on the rise in a variety of different industries and sectors. A blockchain is a decentralized, distributed, and public digital ledger that may be used to record transactions across many computing devices. Recorded transactions cannot be altered retroactively without the alteration of all subsequent blocks. This allows the recorded transactions to be verified and audited with little cost. Each record may include a time stamp and reference links to previous transactions. A blockchain can be managed autonomously via a peer-to-peer network and a distributed timestamping server.

### SUMMARY

In some embodiments, a non-transitory machine-readable medium stores a program. The program receives a transaction from a transaction source. Based on a set of rules configured for processing transactions, the program further determines a blockchain from a plurality of blockchains stored in memory of the device. The program also records the transaction to the determined blockchain in the memory of the device.

In some embodiments, the program may further generate an incremental, unique identifier and associate the incremental, unique identifier to the transaction. The blockchain may be a first blockchain. The program may further receive a request from a client device to access to a second blockchain in the plurality of blockchains in the memory of the device; determine whether a user of the client device is authorized to access the second blockchain; and, based on the determination, provide access the user of the client device access to the second blockchain. The receiving, determining, and recording may be performed in real-time. The transaction may be immutable after the transaction is recorded in the blockchain.

In some embodiments, the program may further retrieve a key associated with the transaction source and use the key to decrypt the transaction. The program may further generate a message acknowledging that the transaction is stored in the blockchain; and send the message to the transaction source.

In some embodiments, a method, executable by a device receives a transaction from a transaction source. Based on a set of rules configured for processing transactions, the method further determines a blockchain from a plurality of blockchains stored in memory of the device. The method also records the transaction to the determined blockchain in the memory of the device.

In some embodiments, the method may further generate an incremental, unique identifier and associate the incremental, unique identifier to the transaction. The method may further receive a request from a client device to access to a second blockchain in the plurality of blockchains in the memory of the device; determine whether a user of the client device is authorized to access the second blockchain; and, based on the determination, provide access the user of the client device access to the second blockchain. The receiving, determining, and recording may be performed in real-time. The transaction may be immutable after the transaction is recorded in the blockchain.

In some embodiments, the method may further retrieve a key associated with the transaction source and use the key to decrypt the transaction. The method may further generate a message acknowledging that the transaction is stored in the blockchain and send the message to the transaction source.

In some embodiments, a system includes a set of processing units and a non-transitory machine-readable medium that stores instructions. The instructions cause at least one processing unit to receive a transaction from a transaction source. Based on a set of rules configured for processing transactions, the instructions further cause the at least one processing unit to determine a blockchain from a plurality of blockchains stored in memory of the device. The instructions also cause the at least one processing unit to record the transaction to the determined blockchain in the memory of the device.

In some embodiments, the instructions may further cause the at least one processing unit to generate an incremental, unique identifier and associate the incremental, unique identifier to the transaction. The instructions may further cause the at least one processing unit to receive a request from a client device to access to a second blockchain in the plurality of blockchains in the memory of the device; determine whether a user of the client device is authorized to access the second blockchain; and, based on the determination, provide access the user of the client device access to the second blockchain. The receiving, determining, and recording may be performed in real-time. The transaction may be immutable after the transaction is recorded in the blockchain.

In some embodiments, the instructions may further cause the at least one processing unit to retrieve a key associated with the transaction source and use the key to decrypt the transaction.

The following detailed description and accompanying drawings provide a better understanding of the nature and advantages of the present invention.

### BRIEF DESCRIPTION OF THE DRAWINGS

FIG. 1 illustrates a system for managing centralized blockchains and processing blockchain transactions in real-time according to some embodiments.

FIG. 2 illustrates a dataflow through the system illustrated in FIG. 1 according to some embodiments.

FIG. 3 illustrates a process for processing blockchain transactions according to some embodiments.

FIG. 4 illustrates an exemplary computer system, in which various embodiments may be implemented.

FIG. 5 illustrates an exemplary computing device, in which various embodiments may be implemented.

FIG. 6 illustrates an exemplary system, in which various embodiments may be implemented.

### DETAILED DESCRIPTION

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Described herein are techniques for real-time processing of transactions for centralized blockchains. In some embodiments, a computing system is configured to manage blockchains locally in the memory of the computing system. The computing system may process transactions from any number of transaction sources. For instance, when the computing system receive a transaction from a transaction source, the computing system may decrypt the transaction, verify information associated with the transaction, and associate a unique identifier with the transaction. Next, the computing system determines the validity of the transaction and verifies the transaction. Then, the computing system determines one of the blockchains in which the transaction is to be stored. After storing the transactions in the blockchain, the computing system sends the transaction source a message indicating that the transaction has been processed.

The techniques described in the present application provide a number of benefits and advantages over conventional methods for processing transactions for blockchains. First, managing and storing blockchains in memory of a computing system allows transactions for blockchains to be processed faster (e.g., in real-time) than traditional distributed blockchains that are typically managed on secondary storage (e.g., hard disk drives) in a peer-to-peer network. Second, not encrypting transactions in the blockchains also allows transactions for blockchains to be processed faster (e.g., in real-time) than traditional distributed blockchains that are encrypted in the blockchain. Third, managing multiple different blockchains on a single host or computing system provides more privacy and better control of access to the blockchains than traditional distributed blockchains that may be accessed by anyone.

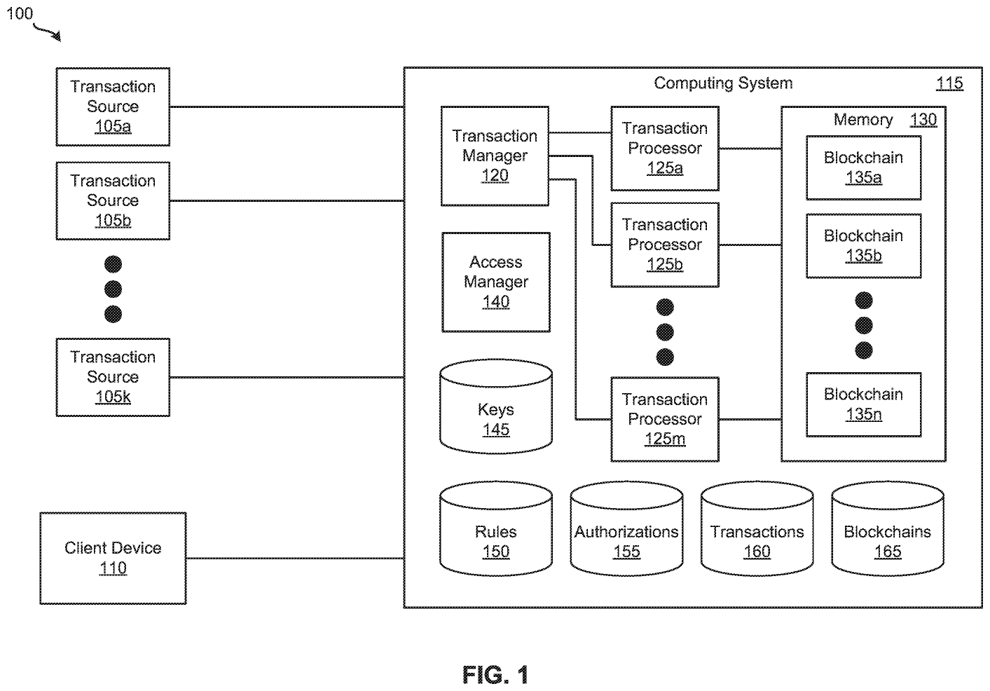

FIG. 1 illustrates a system 100 for managing centralized blockchains and processing blockchain transactions in real-time according to some embodiments. In some embodiments, a blockchain transaction is processed in real-time when system 100 completes the processing of the blockchain transaction (e.g., computing system 115 sending a transaction source 105 a message indicating that the blockchain transaction has been processed) in less than one second. As shown, system 100 includes transaction sources 105a-k, client device 110, and computing system 115. Each of the transaction sources 105a-k is configured to send transactions to computing system 115 for recording in blockchains. A transaction source 105 may be an application, a service, a computing device, a client device (e.g., client device 110), a computing system, etc. or any other type of source configure to send transactions to computing system 115. A transaction can specify a sender, a receiver, an amount, a currency associated with the amount, etc.

In some embodiments, each of the transaction sources 105a-k performs a key exchange with computing system 115 before the transaction source 105 sends transactions to computing system 115. For example, if a symmetrical key is used, a transaction source 105 generates the symmetrical key and sends computing system 115 the generated key. In such instances, when the transaction source 105 sends a transaction to computing system 115, the transaction source 105 generates the transaction, encrypts the transaction with the symmetrical key, and then sends the encrypted transaction to computing system 115. If asymmetrical key are used, a transaction source 105 generates a public and private key pair and sends computing system 115 the generated public key while storing the private key. In such cases, when the transaction source 105 sends a transaction to computing system 115, the transaction source 105 generates the transaction, encrypts the transaction with the private key, and then sends the encrypted transaction to computing system 115. In some cases, each of the transaction sources 105a-k generates a digital signature and sends it along with the transaction to computing system 115. To generate a digital signature, a transaction source 105 may generate a hash of the transaction (e.g., using a hash function) and encrypt the hash with a key (e.g., a symmetrical key or an asymmetrical key (e.g., a private key)).

Client device 110 is configured to communicate and interact with computing system 115. For example, a user of client device 110 can access computing system 115 and provide rules for processing blockchain transactions. For instance, a user of client device 110 can access computing system 115 and provide a set of rules that specify which transactions are stored in which blockchains. As an example, such a set of rules may specify that transactions associated with small-sized entities be stored in a first blockchain, transactions associated with medium-sized entities be stored in a second blockchain, and transactions associated with large-sized entities be stored in a third blockchain. The set of rules can specify that transactions associated with different-sized entities based on revenue be stored in different blockchains (e.g., transactions associated with small revenue entities stored in a first blockchain, transactions associated with medium revenue entities be stored in a second blockchain, and transactions associated with large revenue entities be stored in a third blockchain). As another example, the set of rules may specify that transactions from a first transaction source 105 be stored in a first blockchain, transactions from a second transaction source 105 be stored in a second blockchain, transactions from a third transaction source 105 be stored in a third blockchain, etc. As yet another example, the set of rules may specify that transactions with the same party or parties be stored in the same blockchain. One of ordinary skill in the art will appreciate that any number of additional and/or different criteria may be used to determine which blockchains to store which transactions. Further, a user of client device 110 may access computing system 115 and provide a set of rules for determining the validity of transactions and verifying transactions. For instance, such a set of rules can specify thresholds for amounts of transactions (e.g., a transaction amount of $10 k USD or less is valid, a transaction amount of less than $0 USD is not valid, etc.). One of ordinary skill in the art will realize that any number of additional and/or different sets of rules for processing transactions may be provided to computing system 115. In addition, a user of client device 110 may access computing system 115 and provide authorization information. The authorization information can specify which users are allowed to access which blockchains. In some embodiments, the authorization information includes mappings of user identifiers (IDs) and blockchain IDs.

In some embodiments, computing system 115 is configured to locally manage blockchains (e.g., blockchains 135a-n). Computing system 115 can serve as a centralized, private computing system configured for managing blockchains. As illustrated in FIG. 1, computing system 115 includes transaction manager 120, transaction processors 125a-m, memory 130, access manager 140, and storages 145-165. Keys storage 145 is configured to store keys received from transaction sources 105a-k. As mentioned above, a transaction source 105 can send computing system 115 a symmetrical key or an asymmetrical key. When computing system 115 receives a key, computing system stores it in keys storage 145 along with a mapping of the key and which transactions source 105 (e.g., a transaction source ID) the key was received from. Rules storage 150 stores rules that specify which transactions are stored in which blockchains. As described above, computing system 115 may receive such rules from client device 110. Upon receiving such rules, computing system 115 stores them in rules storage 150. Authorizations storage 155 is configured to store authorization information that specify which users are allowed to access which blockchains. As explained above, computing system 115 may receive such rules from client device 110. After receiving such rules, computing system 115 stores them in authorizations storage 155. Transactions storage 160 stores transactions that have been written to blockchains. Blockchains storage 165 is configured to store blockchains. In some embodiments, storages 145-165 are implemented in a single physical storage while, in other embodiments, storages 145-165 may be implemented across several physical storages. While FIG. 1 shows storages 145-165 as part of computing system 115, one of ordinary skill in the art will appreciate that keys storage 145, rules storage 150, authorizations storage 155, transactions storage 160, and/or blockchains storage 165 may be external to computing system 115 in some embodiments.

Transaction manager 120 is responsible for handling transactions received from transaction sources 105a-k. For example, transaction manager 120 may receive a transaction from a transaction source 105. In response, transaction manager 120 accesses keys storage 145 to identify and retrieve a key associated with the transaction source 105. Then, transaction manager 120 uses the retrieved key to decrypt the transaction. Next, transaction manager 120 verifies the sender of the transaction as well as the integrity of the information associated with the transaction. As mentioned above, in some cases, a transaction source 105 may send a digital signature along with the transaction. In some such cases, upon receiving the transaction and the digital signature, transaction manager 120, transaction manager 120 uses the retrieved key to decrypt the digital signature. Then, transaction manager 120 generates a hash of the transaction (e.g., using the same hash function used by transaction sources 105a-k) and compares the hash of the transaction with the decrypted digital signature. If they match, transaction manager 120 determines that the sender is valid (e.g., verifies that the transaction source is the legitimate sender of the transaction).

Transaction manager 120 then generates an incremental, unique ID and associates the incremental, unique identifier with the transaction. For example, transaction manager 120 may use unique integers as the unique ID. In such cases, transaction manager 120 keeps track of the most recently generated integer and, for the next transaction, generates an integer by incrementing the recently generated integer by a defined amount (e.g., one, three, five, ten, etc.) and associates it with this transaction. In this manner, the order of transactions received may be guaranteed even if the transactions end up being written to blockchains 135an out of order. Once transaction manager 120 generates a unique ID and associates it with the transaction, transaction manager 120 sends the transaction and the unique ID to one of the transaction processors 125a-m. In some embodiments, transaction manager 120 uses a round robin technique to select a transaction processor 125 to which the transaction and unique ID are sent. One of ordinary skill in the art will understand that any number of techniques (e.g., load-balancing techniques such as a consistent hashing technique a fastest response technique, a least connections or load technique, etc.) may be used to select a transaction processor 125.

Each of the transaction processors 125a-m is configured to process transactions received from transaction manager 120. For instance, a transaction processor 125 can receive a transaction and a unique ID from transaction manager 120. In response, the transaction processor 125 accesses rules storage 150 to retrieve rules for processing transactions. The transaction processor 125 uses rules to determine the validity of the transaction and verify the transaction. Next, the transaction processor 125 uses the rules to determine which of the blockchains 135a-n to record the transaction in. Once that has been determined, the transaction processor 125 records the transaction in the determined blockchain 135 of memory 130. The transaction processor 125 can use any number of different blockchain technologies to record the transaction in the determined blockchain 135 of memory 130. For example, the transaction processor 125 can encrypt the transaction and sign the transaction as part of the recording process. Once a transaction is recorded in a blockchain, the transaction is immutable.

As shown in FIG. 1, memory 130 includes blockchains 135a-n. Each of the blockchains 135a-n is configured to store transactions in a blockchain using any number of different blockchain technologies. In some embodiments, the data in a blockchain 135 is stored as a hash tree or a Merkel tree. Access manager 140 is responsible for managing access to blockchains 135a-n. For example, access manager 140 can receive from a user of a client device (e.g., client device 110 or the like) a request to access a blockchain 135n. In response, access manager 140 accesses authorizations storage 155 to determine whether the user is authorized to access the requested blockchain 135. As mentioned above, in some embodiments, the authorization information stored in authorizations storage 155 includes mappings of user IDs and blockchain IDs. If authorizations storage 155 has a mapping of the user ID of the user and the blockchain ID of the requested blockchain 135, access manager 140 gives the user of the client device access to the requested blockchain 135. Otherwise, access manage 140 denies the user of the client device access to the requested blockchain 135.

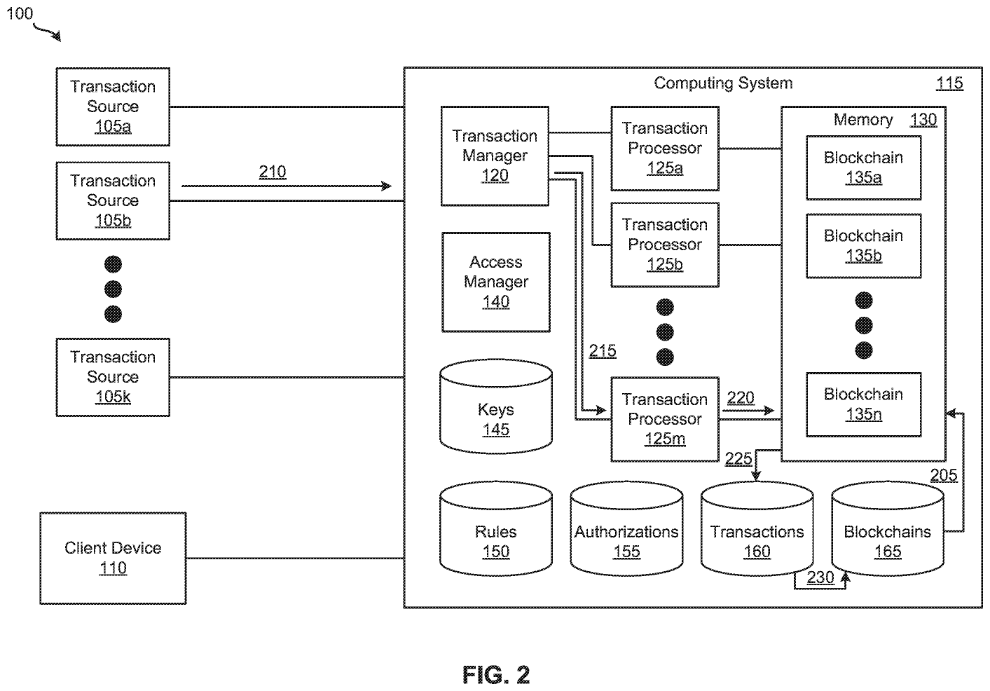

An example operation will now be described by reference to FIG. 2. FIG. 2 illustrates a dataflow through system 100 according to some embodiments. The example operation starts by a blockchain application or service (not shown) configured to execute on computing system 115. During the startup of the blockchain application or service, blockchains stored in blockchains storage 165 are copied, at 205, into memory 130. Next, transaction manager 120 receives, at 210, a transaction from transaction source 105b that was encrypted by transaction source 105b (e.g., by using a symmetrical key or asymmetrical key (e.g., a private key)). When transaction manager 120 receives the encrypted transaction, transaction manager 120 accesses keys storage 145 to retrieve the key associated with transaction source 105b. Transaction manager 120 uses the key to decrypt the transaction. In addition, transaction manager 120 verifies the sender of the transaction as well as the integrity of the information associated with the transaction. Next, transaction manager 120 generates an incremental, unique ID and associates the incremental, unique identifier with the transaction. Transaction manager 120 then selects transaction processor 125m to process the transaction and sends, at 215 the transaction and the unique ID to transaction processors 125m.

Upon receiving the transaction and the unique ID, transaction processor 125m accesses rules storage 150 to retrieve rules for processing transactions. Transaction processor 125m uses the rules to determine the validity of the transaction and verify the transaction. Additionally, transaction processor 125m uses the rules to determine which of the blockchains 135a-n to record the transaction in. For this example, transaction processor 125m determines to record the transaction in blockchain 135a and record, at 220, it in blockchain 135a of memory 130. Next, transactions processor 125m also stores, at 225, the transaction and a reference to blockchain 135a (e.g., a blockchain ID associated with blockchain 135a) in transactions storage 160. At defined intervals or defined times, computing system 115 records, at 230, the transactions stored in transactions storage 160 to the corresponding blockchains in blockchains storage 165.

In the example operation described above, blockchains stored in blockchains storage 165 are copied into memory 130 during the startup of the blockchain application or service. In some embodiments, memory 130 may be implemented using non-volatile memory (e.g., non-volatile random access memory (NVRAM)). In some such embodiments, computing system 115 does not utilize transactions storage 160 and blockchains storage 165 since blockchains 135a-n can be stored in non-volatile memory while computing system 115 is operating and while computing system 115 is powered off. Thus, in some such embodiments, transactions recorded in blockchains 135a-n in memory 130 are not stored in transactions storage 160 and subsequently recorded in blockchains in blockchains storage 165.

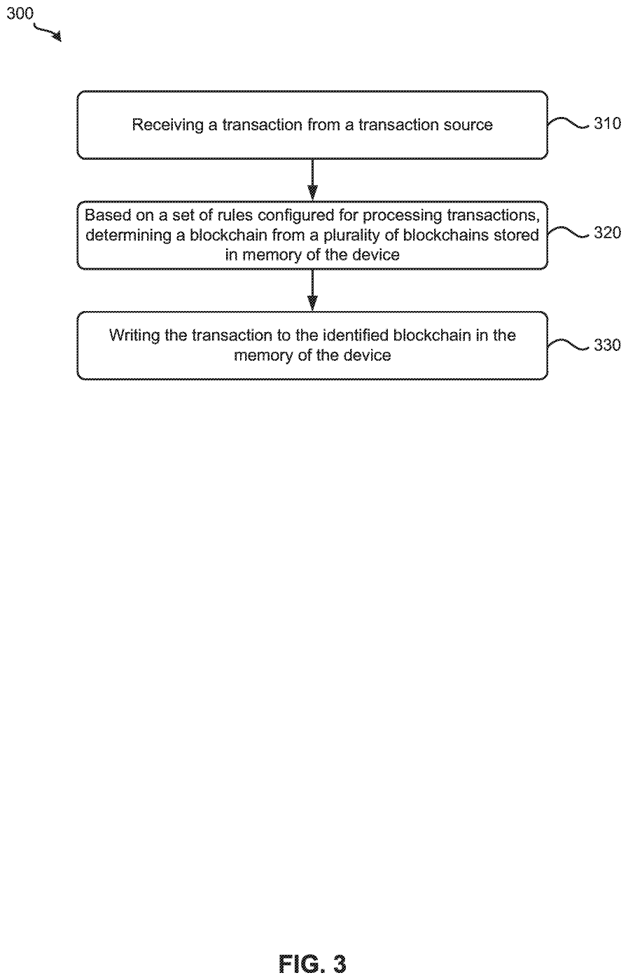

FIG. 3 illustrates a process 300 for processing blockchain transactions according to some embodiments. In some embodiments, computing system 115 performs process 300. Process 300 begins by receiving, at 310, a transaction from a transaction source. Referring to FIG. 2 as an example, transaction manager 120 can receive a transaction from transaction source 105b. In response, transaction manager 120 accesses keys storage 145 to retrieve the key associated with transaction source 105b and uses the key to decrypt the transaction. Also, transaction manager 120 verifies the sender of the transaction as well as the integrity of the information associated with the transaction. Transaction manager 120 may also generate an incremental, unique ID and associate the incremental, unique identifier with the transaction. Transaction manager 120 selects transaction processor 125m to process the transaction and sends the transaction and the unique ID to transaction processors 125m.

Next, process 300, determines, at 320, a blockchain from a plurality of blockchains stored in memory of the device based on a set of rules configured for processing transactions. Referring to FIG. 2 as an example, transaction processor 125m may determine a blockchain 135 from the plurality of blockchains 135a-n stored in memory 130 based on rules retrieved from rules storage 150.

Finally, process 300 records, at 330, the transaction to the determined blockchain in the memory of the device. Referring to FIG. 2 as an example, transaction processor 125m can record the transaction in blockchain 135a, which is the determined blockchain, of memory 130. In some instances, transactions processor 125m may further store the transaction and a reference to blockchain 135a (e.g., a blockchain ID associated with blockchain 135a) in transactions storage 160. Then, at defined intervals or defined times, computing system 115 can record the transactions stored in transactions storage 160 to the corresponding blockchain in blockchains storage 165.

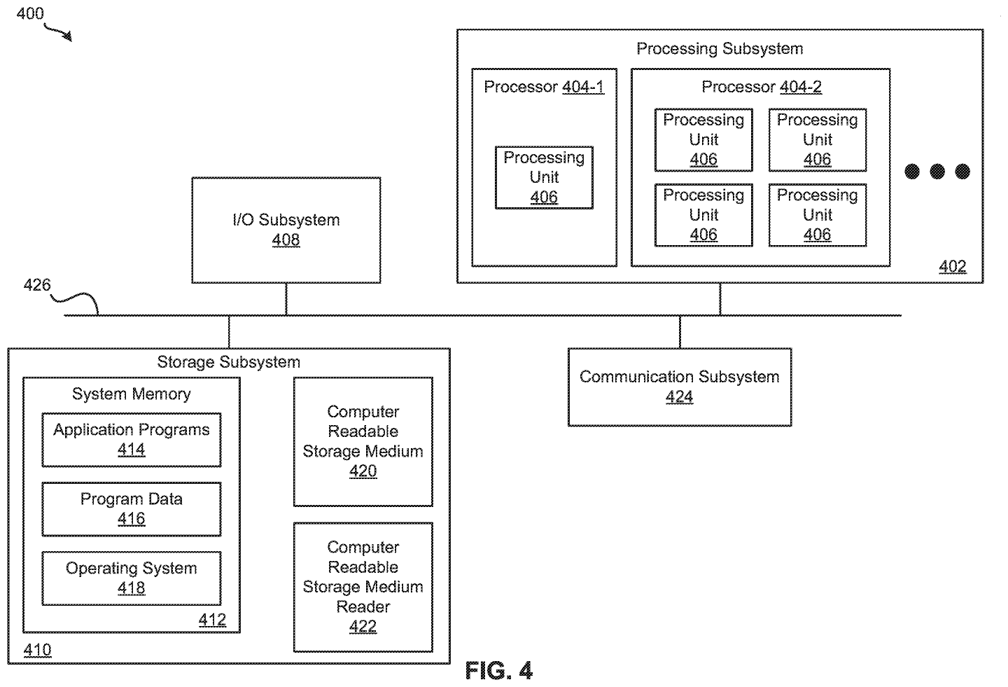

FIG. 4 illustrates an exemplary computer system 400 for implementing various embodiments described above. For example, computer system 400 may be used to implement transaction sources 105a-k, client device 110, and computing system 115. Computer system 400 may be a desktop computer, a laptop, a server computer, or any other type of computer system or combination thereof. Some or all elements of transaction manager 120, transaction processors 125a-m, memory 130, access manager 140, or combinations thereof can be included or implemented in computer system 400. In addition, computer system 400 can implement many of the operations, methods, and/or processes described above (e.g., process 300). As shown in FIG. 4, computer system 400 includes processing subsystem 402, which communicates, via bus subsystem 426, with input/output (I/O) subsystem 408, storage subsystem 410 and communication subsystem 424.

Bus subsystem 426 is configured to facilitate communication among the various components and subsystems of computer system 400. While bus subsystem 426 is illustrated in FIG. 4 as a single bus, one of ordinary skill in the art will understand that bus subsystem 426 may be implemented as multiple buses. Bus subsystem 426 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Universal Serial Bus (USB), etc.

Processing subsystem 402, which can be implemented as one or more integrated circuits (e.g., a conventional microprocessor or microcontroller), controls the operation of computer system 400. Processing subsystem 402 may include one or more processors 404. Each processor 404 may include one processing unit 406 (e.g., a single core processor such as processor 404-1) or several processing units 406 (e.g., a multicore processor such as processor 404-2). In some embodiments, processors 404 of processing subsystem 402 may be implemented as independent processors while, in other embodiments, processors 404 of processing subsystem 402 may be implemented as multiple processors integrate into a single chip or multiple chips. Still, in some embodiments, processors 404 of processing subsystem 402 may be implemented as a combination of independent processors and multiple processors integrated into a single chip or multiple chips.

In some embodiments, processing subsystem 402 can execute a variety of programs or processes in response to program code and can maintain multiple concurrently executing programs or processes. At any given time, some or all of the program code to be executed can reside in processing subsystem 402 and/or in storage subsystem 410. Through suitable programming, processing subsystem 402 can provide various functionalities, such as the functionalities described above by reference to process 300, etc.

I/O subsystem 408 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 400 to a user or another device (e.g., a printer).

As illustrated in FIG. 4, storage subsystem 410 includes system memory 412, computer-readable storage medium 420, and computer-readable storage medium reader 422. System memory 412 may be configured to store software in the form of program instructions that are loadable and executable by processing subsystem 402 as well as data generated during the execution of program instructions. In some embodiments, system memory 412 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 412 may include different types of memory, such as static random access memory (SRAM) and/or dynamic random access memory (DRAM). System memory 412 may include a basic input/output system (BIOS), in some embodiments, that is configured to store basic routines to facilitate transferring information between elements within computer system 400 (e.g., during start-up). Such a BIOS may be stored in ROM (e.g., a ROM chip), flash memory, or any other type of memory that may be configured to store the BIOS.

As shown in FIG. 4, system memory 412 includes application programs 414, program data 416, and operating system (OS) 418. OS 418 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 420 may be a non-transitory computer-readable medium configured to store software (e.g., programs, code modules, data constructs, instructions, etc.). Many of the components (e.g., transaction manager 120, transaction processors 125a-m, memory 130, and access manager 140) and/or processes (e.g., process 300) described above may be implemented as software that when executed by a processor or processing unit (e.g., a processor or processing unit of processing subsystem 402) performs the operations of such components and/or processes. Storage subsystem 410 may also store data used for, or generated during, the execution of the software.

Storage subsystem 410 may also include computer-readable storage medium reader 422 that is configured to communicate with computer-readable storage medium 420. Together and, optionally, in combination with system memory 412, computer-readable storage medium 420 may comprehensively represent remote, local, fixed, and/or removable storage devices plus storage media for temporarily and/or more permanently containing, storing, transmitting, and retrieving computer-readable information.

Computer-readable storage medium 420 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSD), flash memory card (e.g., secure digital (SD) cards, CompactFlash cards, etc.), USB flash drives, or any other type of computer-readable storage media or device.

Communication subsystem 424 serves as an interface for receiving data from, and transmitting data to, other devices, computer systems, and networks. For example, communication subsystem 424 may allow computer system 400 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 424 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 424 may provide components configured for wired communication (e.g., Ethernet) in addition to or instead of components configured for wireless communication.

One of ordinary skill in the art will realize that the architecture shown in FIG. 4 is only an example architecture of computer system 400, and that computer system 400 may have additional or fewer components than shown, or a different configuration of components. The various components shown in FIG. 4 may be implemented in hardware, software, firmware or any combination thereof, including one or more signal processing and/or application specific integrated circuits.

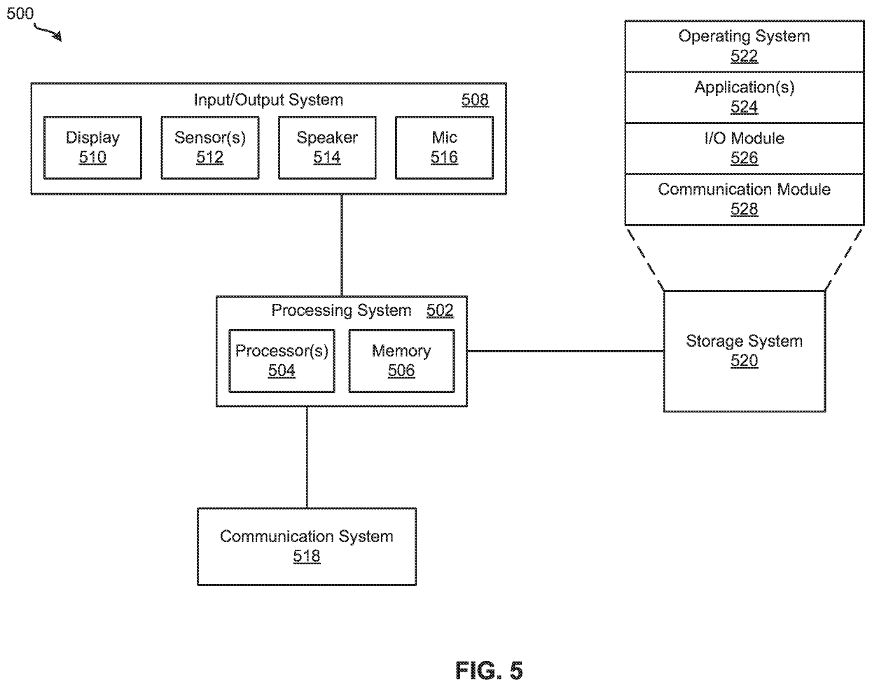

FIG. 5 illustrates an exemplary computing device 500 for implementing various embodiments described above. For example, computing device 500 may be used to implement transaction sources 105a-k and client device 110. Computing device 500 may be a cellphone, a smartphone, a wearable device, an activity tracker or manager, a tablet, a personal digital assistant (PDA), a media player, or any other type of mobile computing device or combination thereof. As shown in FIG. 5, computing device 500 includes processing system 502, input/output (I/O) system 508, communication system 518, and storage system 520. These components may be coupled by one or more communication buses or signal lines.

Processing system 502, which can be implemented as one or more integrated circuits (e.g., a conventional microprocessor or microcontroller), controls the operation of computing device 500. As shown, processing system 502 includes one or more processors 504 and memory 506. Processors 504 are configured to run or execute various software and/or sets of instructions stored in memory 506 to perform various functions for computing device 500 and to process data.

Each processor of processors 504 may include one processing unit (e.g., a single core processor) or several processing units (e.g., a multicore processor). In some embodiments, processors 504 of processing system 502 may be implemented as independent processors while, in other embodiments, processors 504 of processing system 502 may be implemented as multiple processors integrate into a single chip. Still, in some embodiments, processors 504 of processing system 502 may be implemented as a combination of independent processors and multiple processors integrated into a single chip.

Memory 506 may be configured to receive and store software (e.g., operating system 522, applications 524, I/O module 526, communication module 528, etc. from storage system 520) in the form of program instructions that are loadable and executable by processors 504 as well as data generated during the execution of program instructions. In some embodiments, memory 506 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 508 is responsible for receiving input through various components and providing output through various components. As shown for this example, I/O system 508 includes display 510, one or more sensors 512, speaker 514, and microphone 516. Display 510 is configured to output visual information (e.g., a graphical user interface (GUI) generated and/or rendered by processors 504). In some embodiments, display 510 is a touch screen that is configured to also receive touch-based input. Display 510 may be implemented using liquid crystal display (LCD) technology, light-emitting diode (LED) technology, organic LED (OLED) technology, organic electro luminescence (OEL) technology, or any other type of display technologies. Sensors 512 may include any number of different types of sensors for measuring a physical quantity (e.g., temperature, force, pressure, acceleration, orientation, light, radiation, etc.). Speaker 514 is configured to output audio information and microphone 516 is configured to receive audio input. One of ordinary skill in the art will appreciate that I/O system 508 may include any number of additional, fewer, and/or different components. For instance, I/O system 508 may include a keypad or keyboard for receiving input, a port for transmitting data, receiving data and/or power, and/or communicating with another device or component, an image capture component for capturing photos and/or videos, etc.

Communication system 518 serves as an interface for receiving data from, and transmitting data to, other devices, computer systems, and networks. For example, communication system 518 may allow computing device 500 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 518 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 518 may provide components configured for wired communication (e.g., Ethernet) in addition to or instead of components configured for wireless communication.

Storage system 520 handles the storage and management of data for computing device 500. Storage system 520 may be implemented by one or more non-transitory machine-readable mediums that are configured to store software (e.g., programs, code modules, data constructs, instructions, etc.) and store data used for, or generated during, the execution of the software.

In this example, storage system 520 includes operating system 522, one or more applications 524, I/O module 526, and communication module 528. Operating system 522 includes various procedures, sets of instructions, software components and/or drivers for controlling and managing general system tasks (e.g., memory management, storage device control, power management, etc.) and facilitates communication between various hardware and software components. Operating system 522 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 524 can include any number of different applications installed on computing device 500. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 526 manages information received via input components (e.g., display 510, sensors 512, and microphone 516) and information to be outputted via output components (e.g., display 510 and speaker 514). Communication module 528 facilitates communication with other devices via communication system 518 and includes various software components for handling data received from communication system 518.

One of ordinary skill in the art will realize that the architecture shown in FIG. 5 is only an example architecture of computing device 500, and that computing device 500 may have additional or fewer components than shown, or a different configuration of components. The various components shown in FIG. 5 may be implemented in hardware, software, firmware or any combination thereof, including one or more signal processing and/or application specific integrated circuits.

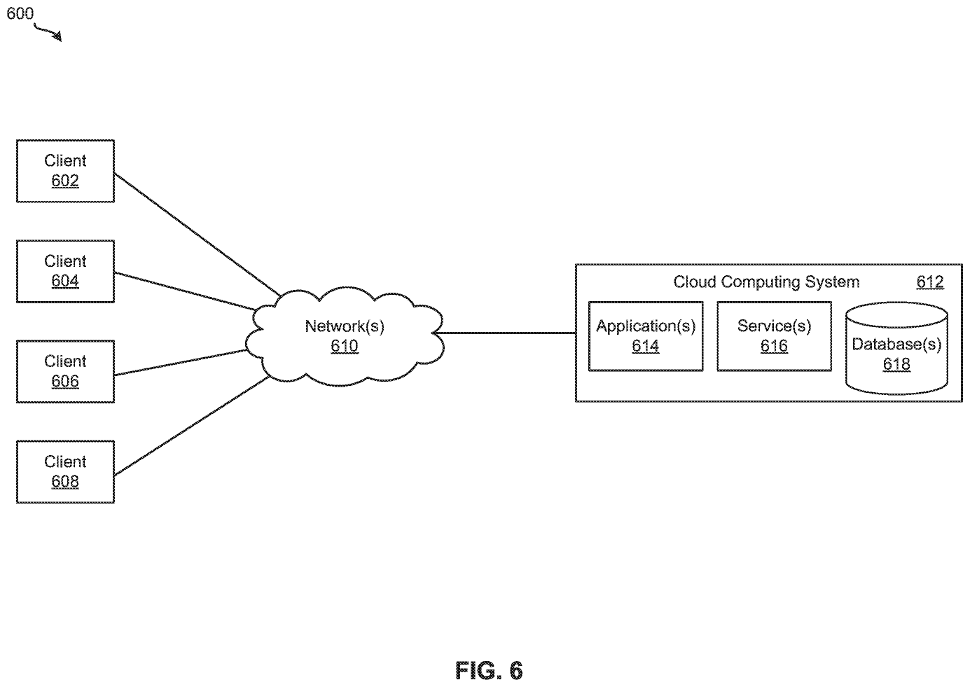

FIG. 6 illustrates an exemplary system 600 for implementing various embodiments described above. For example, client devices 602-608 may be used to implement transaction sources 105a-k and client device 110. In addition, cloud computing system 612 of system 600 may be used to implement computing system 115. As shown, system 600 includes client devices 602-608, one or more networks 610, and cloud computing system 612. Cloud computing system 612 is configured to provide resources and data to client devices 602-608 via networks 610. In some embodiments, cloud computing system 600 provides resources to any number of different users (e.g., customers, tenants, organizations, etc.). Cloud computing system 612 may be implemented by one or more computer systems (e.g., servers), virtual machines operating on a computer system, or a combination thereof.

As shown, cloud computing system 612 includes one or more applications 614, one or more services 616, and one or more databases 618. Cloud computing system 600 may provide applications 614, services 616, and databases 618 to any number of different customers in a self-service, subscription-based, elastically scalable, reliable, highly available, and secure manner.

In some embodiments, cloud computing system 600 may be adapted to automatically provision, manage, and track a customer's subscriptions to services offered by cloud computing system 600. Cloud computing system 600 may provide cloud services via different deployment models. For example, cloud services may be provided under a public cloud model in which cloud computing system 600 is owned by an organization selling cloud services and the cloud services are made available to the general public or different industry enterprises. As another example, cloud services may be provided under a private cloud model in which cloud computing system 600 is operated solely for a single organization and may provide cloud services for one or more entities within the organization. The cloud services may also be provided under a community cloud model in which cloud computing system 600 and the cloud services provided by cloud computing system 600 are shared by several organizations in a related community. The cloud services may also be provided under a hybrid cloud model, which is a combination of two or more of the aforementioned different models.

In some instances, any one of applications 614, services 616, and databases 618 made available to client devices 602-608 via networks 610 from cloud computing system 600 is referred to as a “cloud service.” Typically, servers and systems that make up cloud computing system 600 are different from the on-premises servers and systems of a customer. For example, cloud computing system 600 may host an application and a user of one of client devices 602-608 may order and use the application via networks 610.

Applications 614 may include software applications that are configured to execute on cloud computing system 612 (e.g., a computer system or a virtual machine operating on a computer system) and be accessed, controlled, managed, etc. via client devices 602-608. In some embodiments, applications 614 may include server applications and/or mid-tier applications (e.g., HTTP (hypertext transport protocol) server applications, FTP (file transfer protocol) server applications, CGI (common gateway interface) server applications, JAVA server applications, etc.). Services 616 are software components, modules, application, etc. that are configured to execute on cloud computing system 612 and provide functionalities to client devices 602-608 via networks 610. Services 616 may be web-based services or on-demand cloud services.

Databases 618 are configured to store and/or manage data that is accessed by applications 614, services 616, and/or client devices 602-608. For instance, storages 145-165 may be stored in databases 618. Databases 618 may reside on a non-transitory storage medium local to (and/or resident in) cloud computing system 612, in a storage-area network (SAN), on a non-transitory storage medium local located remotely from cloud computing system 612. In some embodiments, databases 618 may include relational databases that are managed by a relational database management system (RDBMS). Databases 618 may be a column-oriented databases, row-oriented databases, or a combination thereof. In some embodiments, some or all of databases 618 are in-memory databases. That is, in some such embodiments, data for databases 618 are stored and managed in memory (e.g., random access memory (RAM)).

Client devices 602-608 are configured to execute and operate a client application (e.g., a web browser, a proprietary client application, etc.) that communicates with applications 614, services 616, and/or databases 618 via networks 610. This way, client devices 602-608 may access the various functionalities provided by applications 614, services 616, and databases 618 while applications 614, services 616, and databases 618 are operating (e.g., hosted) on cloud computing system 600. Client devices 602-608 may be computer system 400 or computing device 500, as described above by reference to FIGS. 4 and 5, respectively. Although system 600 is shown with four client devices, any number of client devices may be supported.

Networks 610 may be any type of network configured to facilitate data communications among client devices 602-608 and cloud computing system 612 using any of a variety of network protocols. Networks 610 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A non-transitory machine-readable medium storing a program executable by at least one processing unit of a device, the program comprising sets of instructions for:
receiving a transaction from a transaction source;
based on a set of rules configured for processing transactions, determining a blockchain from a plurality of blockchains stored in memory of the device; and
recording the transaction to the determined blockchain in the memory of the device.

2. The non-transitory machine-readable medium of claim 1, wherein the program further comprises sets of instructions for:
generating an incremental, unique identifier; and
associating the incremental, unique identifier to the transaction.

3. The non-transitory machine-readable medium of claim 1, wherein the blockchain is a first blockchain, wherein the program further comprises sets of instructions for:
receiving a request from a client device to access to a second blockchain in the plurality of blockchains in the memory of the device;
determining whether a user of the client device is authorized to access the second blockchain; and
based on the determination, providing access the user of the client device access to the second blockchain.

4. The non-transitory machine-readable medium of claim 1, wherein the receiving, determining, and recording are performed in real-time.

5. The non-transitory machine-readable medium of claim 1, wherein the transaction is immutable after the transaction is recorded in the blockchain.

6. The non-transitory machine-readable medium of claim 1, wherein the program further comprises sets of instructions for:
retrieving a key associated with the transaction source; and
using the key to decrypt the transaction.

7. The non-transitory machine-readable medium of claim 1, wherein the program further comprises sets of instructions for:
generating a message acknowledging that the transaction is stored in the blockchain; and
sending the message to the transaction source.

8. A method, executable by a device, comprising:
receiving a transaction from a transaction source;
based on a set of rules configured for processing transactions, determining a blockchain from a plurality of blockchains stored in memory of the device; and
recording the transaction to the determined blockchain in the memory of the device.

9. The method of claim 8 further comprising:
generating an incremental, unique identifier; and
associating the incremental, unique identifier to the transaction.

10. The method of claim 8 further comprising:
receiving a request from a client device to access to a second blockchain in the plurality of blockchains in the memory of the device;
determining whether a user of the client device is authorized to access the second blockchain; and
based on the determination, providing access the user of the client device access to the second blockchain.

11. The method of claim 8, wherein the receiving, determining, and recording are performed in real-time.

12. The method of claim 8, wherein the transaction is immutable after the transaction is recorded in the blockchain.

13. The method of claim 8 further comprising:
retrieving a key associated with the transaction source; and
using the key to decrypt the transaction.

14. The method of claim 8 further comprising:
generating a message acknowledging that the transaction is stored in the blockchain; and
sending the message to the transaction source.

15. A system comprising:
a set of processing units; and
a non-transitory machine-readable medium storing instructions that when executed by at least one processing unit in the set of processing units cause the at least one processing unit to:
receive a transaction from a transaction source;
based on a set of rules configured for processing transactions, determine a blockchain from a plurality of blockchains stored in memory of the device; and
record the transaction to the determined blockchain in the memory of the device.

16. The system of claim 15, wherein the instructions further cause the at least one processing unit to:
generate an incremental, unique identifier; and
associate the incremental, unique identifier to the transaction.

17. The system of claim 15, wherein the instructions further cause the at least one processing unit to:
receive a request from a client device to access to a second blockchain in the plurality of blockchains in the memory of the device;
determine whether a user of the client device is authorized to access the second blockchain; and
based on the determination, provide access the user of the client device access to the second blockchain.

18. The system of claim 15, wherein the receiving, determining, and recording are performed in real-time.

19. The system of claim 15, wherein the transaction is immutable after the transaction is recorded in the blockchain.

20. The system of claim 15, wherein the instructions further cause the at least one processing unit to:
retrieve a key associated with the transaction source; and
use the key to decrypt the transaction.
